(19) United States
(12) Patent Application Publication
(10) Pub. No.: US 2014/0234816 A1
(43) Pub. Date: Aug. 21, 2014

(54) Network-Based System for Social Emotional Learning

(71) Applicant: SmartlyU, Inc., Los Altos, CA (US)

(72) Inventors: Sunita Sayana Lokuge, Los Altos, CA (US); Arjuna Chanake Wijeyekoon, Redwood City, CA (US)

(73) Assignee: SmartlyU, Inc., Los Altos, CA (US)

(21) Appl. No.: 14/070,747

(22) Filed: Nov. 4, 2013

Related U.S. Application Data
(60) Provisional application No. 61/767,162, filed on Feb. 20, 2013.

(51) Int. Cl. G09B 23/28

(52) U.S. Cl. CPC G09B 23/28
USPC 434/236

(57) ABSTRACT

A network-based education system for providing social emotional education includes a computer storage that can store a plurality of competencies for social emotional learning and education scenarios for the plurality of competencies, and servers that can enable one of the education scenarios to be presented on a user device. The servers can receive an input from a child user in response to the presentation of the one of the education scenarios. The computer storage can store a child user's history in viewing the education scenarios, input from the child user during the presentation of the education scenarios, and an assessment of the child user's competencies in social emotional skill. An intelligence module can assess the child user's competencies in social emotional skills based in part on the input from the child user during the presentation of the education scenarios.

### BACKGROUND OF THE INVENTION

The present application relates to social emotional learning, and specifically to technologies that enable social emotional learning.

Social Emotional Learning (SEL) provides the capacity to recognize and manage emotions, build positive relationships and solve life problems effectively. SEL skills are shown to be essential to live a life that is fulfilling and happy. SEL skills directly help with positive internal communication within children and the development of strong external communication with peers and adults creating self-expression and confidence. Social and emotional skills also result in fewer problems in the classroom and home. A strong connection has been shown to exist between SEL, school behavior, and academic performance. Children do not learn on their own but in collaboration with their teachers, peers and families. Researchers have found that positive social behavior in the school setting is linked to, and predictive of, positive academic achievement (Haynes, Ben-Avie, & Ensign, 2003; Malecki & Elliott, 2002; Welsh, Park, Widaman, & O′Neil, 2001). In a meta-analysis of school-based programs to promote social and emotional development, researchers found an 11% gain in academic performance in programs that measured SEL and academic effects (Durlak, Weissbert, Dymnicki, Taylor, & Schellinger, 2011).

A challenge to social emotional education is that schools lack tools and curriculum for training teachers and educating children in this area. Another challenge to social emotional education is that the conventional tools use paper based teaching materials and are not widely distributed, and are not easily accessible when they are needed, for example, when behavior problems occur in the classrooms or playgrounds, or when a small segment of time becomes available for one child or a class. Yet another challenge for the computer based learning tools is that they are all focused on academic performances. Still another always present challenge is that teachers, especially public school teachers, constantly joggle between multiple tasks, and are always short of time.

A drawback of the current education system is that parents often do not receive timely feedback on social behaviors of their children from the school system. The current system and tools provide timely and coherent feedback on children's social behaviors to teachers, parents, and counselors. Another drawback of the current education system is that the process is often not in place to actively identify behavior issues before they become serious. Yet, another drawback of the current education system is that there is a lack of quantitative measurement and tracking for social emotional skills for school age children.

There is therefore an urgent need for a flexible, easily accessible, interactive, and quantitative tool for social emotional learning that can be used by children, teachers, and parents.

### SUMMARY OF THE INVENTION

The present disclosure provides a flexible, accessible, interactive, personalized, and quantitative system that can be conveniently used by teachers, parents, students, counselors, and child psychologists for social emotional education. The disclosed systems and methods allow multi-party communications among teachers, parents, students, and counselors. The disclosed system and tools provide simulations of real life situations (i.e. education scenarios) using children's language; the tools are interactive, responsive, and are thus more interesting for children. The disclosed social emotional education system can provide teachers and parents social emotional teaching materials in flexible time segment, and whenever (in or outside classrooms) a child has time to do it. The disclosed system and tools allow schools, teachers, and parents to proactively set goals to develop children's social emotional skills, discover weaknesses and gaps in skills and knowledge, and preemptively prevent and solve problems. The disclosed system and tools are customizable for each child, each family, a school, a specific region, a cultural background, or a country. The disclosed system and tools are also quantitative, and provide benchmarks for each child, a class, or a school. The disclosed system and tools also provide timely and coherent feedback on children's social behaviors to teachers, parents, and counselors.

Teachers, parents, students, child counselors, and child psychologists can access the disclosed system at distributed locations using their own computer or communication devices without having to conduct coaching sessions in person. The disclosed system is easy to grow and update content, and is adaptable to societal and cultural changes. The disclosed system is also scalable to multiple schools, regions, and even different countries.

In one general aspect, the present invention relates to a network-based education system for providing social emotional education that includes a computer storage that can store a plurality of competencies for social emotional learning and education scenarios for the plurality of competencies; one or more servers that can enable one of the education scenarios to be presented on a user device, wherein the one or more servers can receive an input from a child user in response to the presentation of the one of the education scenarios, wherein the computer storage can store a child user's history in viewing the education scenarios, input from the child user during the presentation of the education scenarios, and an assessment of the child user's competencies in social emotional skills; and an intelligence module that can assess the child user's competencies in social emotional skills based in part on the input from the child user during the presentation of the education scenarios.

Implementations of the system may include one or more of the following. At least one of the education scenarios includes an interactive multi-media simulation of a real life situation that involves at least one child character. The interactive multi-media simulation can include selectable multiple choices relating to feelings of a child character involved in the real life situation, wherein the one or more servers can receive a selection of the selectable multiple choices from the child user. The interactive multi-media simulation can include a feedback to the child user's choice in the multiple choices relating to the feelings. The interactive multi-media simulation of the real life situation can include selectable multiple choices for actions that a child character involved in the real life situation should take, wherein the one or more servers can receive a selection of the selectable multiple choices from the child user. The interactive multi-media simulation can include a feedback to the child user's choice in the multiple choices for actions. The interactive multi-media simulation of the real life situation can include verbal communications involving at least one child character. The interactive multi-media simulation of the real life situation can include non-verbal communications involving at least one child character. The intelligence module can to produce guidance to the child user to view one or more of the education scenarios based on the assessment of the child user's competencies in social emotional skills. The computer storage can store a goal for the child user to achieve a level of social emotional skills, wherein the intelligence module can produce guidance to the child user to view one or more of the education scenarios based on the goal for the child user. The one or more servers can enable one of the education scenarios to be presented to the child user based on the age of the child user, wherein the intelligence module is configured to assess the child user's competencies in social emotional skills based in part on the age of the child user. The one or more servers can receive an assignment from a teacher, a parent, or a counselor to require the child user to view one or more of the education scenarios based on the assessment of the child user's competencies in social emotional skills. The one or more servers can send an electronic notification to a teacher, a parent, or a counselor after the child user has reviewed one or more of the education scenarios. The plurality of competencies can be stored in a category selected from the group consisting of relationship skills, managing emotions, personal development, self-awareness, and organization skills. The one or more servers can enable presentation of the one or more education scenarios in a web browser run on the user device, or in a mobile user interface.

In another general aspect, the present invention relates to a computer-implemented method for providing social emotional education. The method includes storing, in a computer storage, a plurality of competencies for social emotional learning and education scenarios for the plurality of competencies, wherein at least one of the education scenarios includes an interactive multi-media simulation of a real life situation that involves at least one child character; enabling one of the education scenarios to be presented on a user device; receiving an input from a child user in response to the presentation of the one of the education scenarios; storing, in the computer storage, a child user's history in viewing the education scenarios, input from the child user during the presentation of the education scenarios, and an assessment of the child user's competencies in social emotional skills; and assessing, by an intelligence module, the child user's competencies in social emotional skills based on the input from the child user during the presentation of the education scenarios.

Implementations of the system may include one or more of the following. The computer-implemented method can further include presenting, in the multi-media simulation, selectable multiple choices relating to feelings of the child or the children involved in the real life situation; receiving a selection of the selectable multiple choices from the child user; and providing a feedback to the child user about his or her choice in the multiple choices relating to the feelings. The computer-implemented method can further include presenting, in the multi-media simulation, selectable multiple choices for actions that a child character should take in the real life situation; receiving a selection of the selectable multiple choices from the child user; and providing a feedback to the child user about his or her choice in the multiple choices relating to the actions. The input from the child can include results of the child user's practices of learning from the education scenarios. The computer-implemented method can further include producing guidance, by the intelligence module, to the child user to view one or more of the education scenarios based on the assessment of the child user's competencies in social emotional skills. The computer-implemented method can further include storing a goal for the child user to achieve a level of social emotional skills in the computer storage; and producing guidance by the intelligence module to the child user to view one or more of the education scenarios based on the goal for the child user. The computer-implemented method can further include enabling one of the education scenarios to be presented to the child user based on an age of the child user; and assessing, by the intelligence module, the child user's competencies in social emotional skills based in part on the age of the child user. The computer-implemented method can further include receiving an assignment by the one or more servers from a teacher, a parent, or a counselor to require the child user to view one or more of the education scenarios based on the assessment of the child user's competencies in social emotional skills. The interactive multi-media simulation of the real life situation includes verbal communications involving at least one child character. The plurality of competencies can be stored in a category selected from the group consisting of relationship skills, managing emotions, personal development, self-awareness, and organization skills.

In another general aspect, the present invention relates to a computer-implemented method for providing social emotional education. The method includes quantitatively defining a plurality of competencies for social emotional learning in a social emotional space that include three or more dimensions; determining a child user's initial state of competency as an initial location in the social emotional space by an intelligence module in a network-based system; setting a goal for social emotional competence for the child user as a destination location in the social emotional space; creating a development path in the social emotional space at least in part with the assistance of the intelligence module; providing education scenarios for the plurality of competencies for the child user to practice, wherein at least one of the education scenarios includes an interactive multi-media simulation of a real life situation that involves at least one child character; and monitoring the child user's progress along the development path by the intelligence module.

The computer-implemented method can further include enabling one of the education scenarios to be presented on a user device; receiving an input from a child user in response to the presentation of the one of the education scenarios; storing, in the computer storage, a child user's history in viewing the education scenarios, input from the child user during the presentation of the education scenarios, and an assessment of the child user's competencies in social emotional skills; and assessing the child user's competencies in social emotional skills based on the input from the child user during the presentation of the education scenarios. The computer-implemented method can further include sharing the development path or the child user's progress along the development path to a parent of the child user.

### BRIEF DESCRIPTION OF THE DRAWINGS

FIG. 1 is a system diagram of schematic view of a network-based system for social emotional learning in accordance with the present invention.

FIGS. 2A-2K are exemplified screens at a user interface for social emotional learning compatible with the network-based system in FIG. 1.

FIG. 3 is a flow chart showing the process that a teacher can assist students in social emotional learning in accordance with the present invention.

FIG. 4 is a flow chart for an exemplified process for social emotional learning in accordance with the present invention.

FIG. 5 shows an exemplified screen at a user interface for social emotional learning compatible with the network-based system in FIG. 1.

FIG. 6 shows a quantitative development path for developing a child's social emotional competencies.

### DETAILED DESCRIPTION OF THE INVENTION

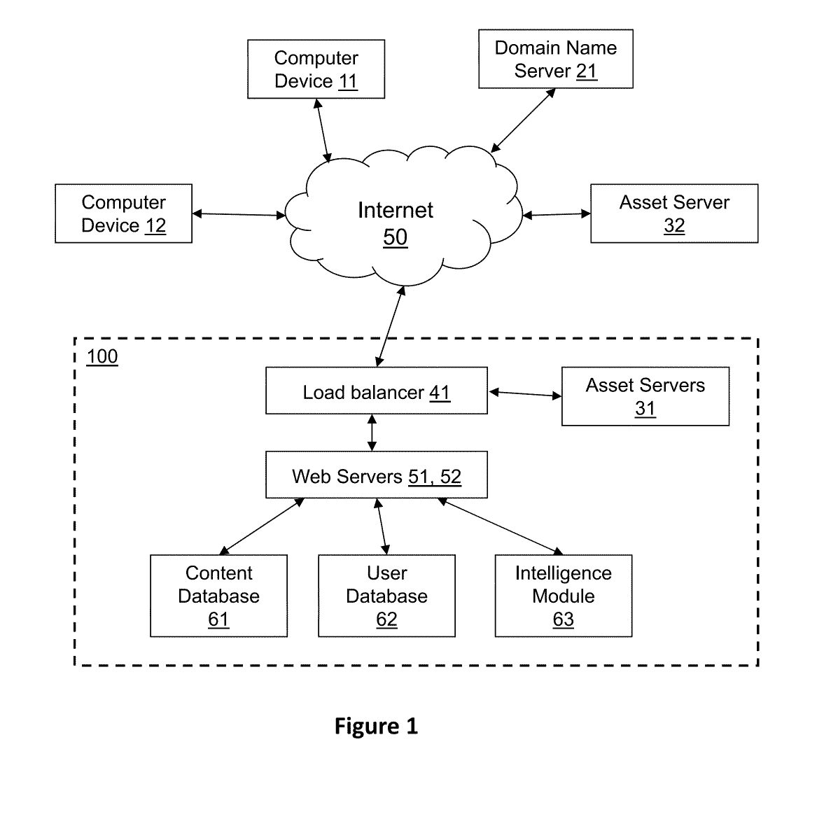

Referring to FIG. 1, a network-based system 100, which can be operated by an education service such as SmartlyU, includes asset servers 31, a load balancer 41, web servers 51, 52, a content database 61, a user database 62, and a SEL intelligence module 63. A student, a teacher, a parent, a counselor, or a child psychologist can use computer devices 11, 12 to access applications supported by the network-based system 100 via Internet 50. An asset server 32 can be included to be located in a distributed mode via the Internet 50 from the network-based system 100. Examples of suitable computer devices can include desktop, laptop, tablet computers, and smartphones, etc. A domain name server (DNS) 21 routes requests from the computer devices 11, 12 to the network-based system 100. The load balancer 41 allocates the request to an available web server 51 or 52. The web servers 51, 52 respond to the requests with HTML after making necessary queries to the content database 61 or the user database 62. The HTML contains assets such as images, audio and video, which are hosted by asset servers 31 and 32. When a device 11 or 12 requests an asset, the DNS 21 routes the request to the nearest asset server 31 or 32. To protect against a database failure, every change written to the content database 61 or the user database 62 can be replicated in a slave database. In the event of a failure in the content database 61 or the user database 62, the system can quickly recover by promoting the slave to master level. The web servers 51, 52 can receive input from and communicate to teachers, parents, and students including during the playing of education scenarios.

The disclosed system can support an application (e.g. SmartlyU application) in the form of a website. In one implementation, the Disclosed application is written in HTML leveraging technologies such as JQuery and Bootstrap. It employs the “responsive web design” technique to fluidly support a wide range of devices, including large screen devices (such as laptops and desktops), small screen devices (such as mobile phones) and intermediary devices (such as tablets).

In online mode, the disclosed application can use HTTP cache headers so that the content is cached locally on the user's device for a certain period of time. This saves the user from having to re-download previously seen content for a period of time. In addition to making the application faster, this conserves the user's bandwidth.

This disclosed system can support an offline mode that can be implemented using HTML5 offline application cache. In this mode, a user may download the application onto any device that supports HTML5 (such as iPhones, other smart phones and tablets) and execute the application without a working network. Any state changes and updates will be cached locally on the user's device (using HTML5 local store). Subsequently, once a working network is detected, all these changes will be synchronized with the web servers 51, 52.

Additional technological features include enhanced support for mobile phones. When a small screen size is detected, low resolution images are used to conserve the user's bandwidth and make the application load faster. Bandwidth and load times across all devices are further reduced by compressing the content on the web servers and asset servers before transmission. The disclosed system can support an application native in the operating system of the computer devices 11 and 12.

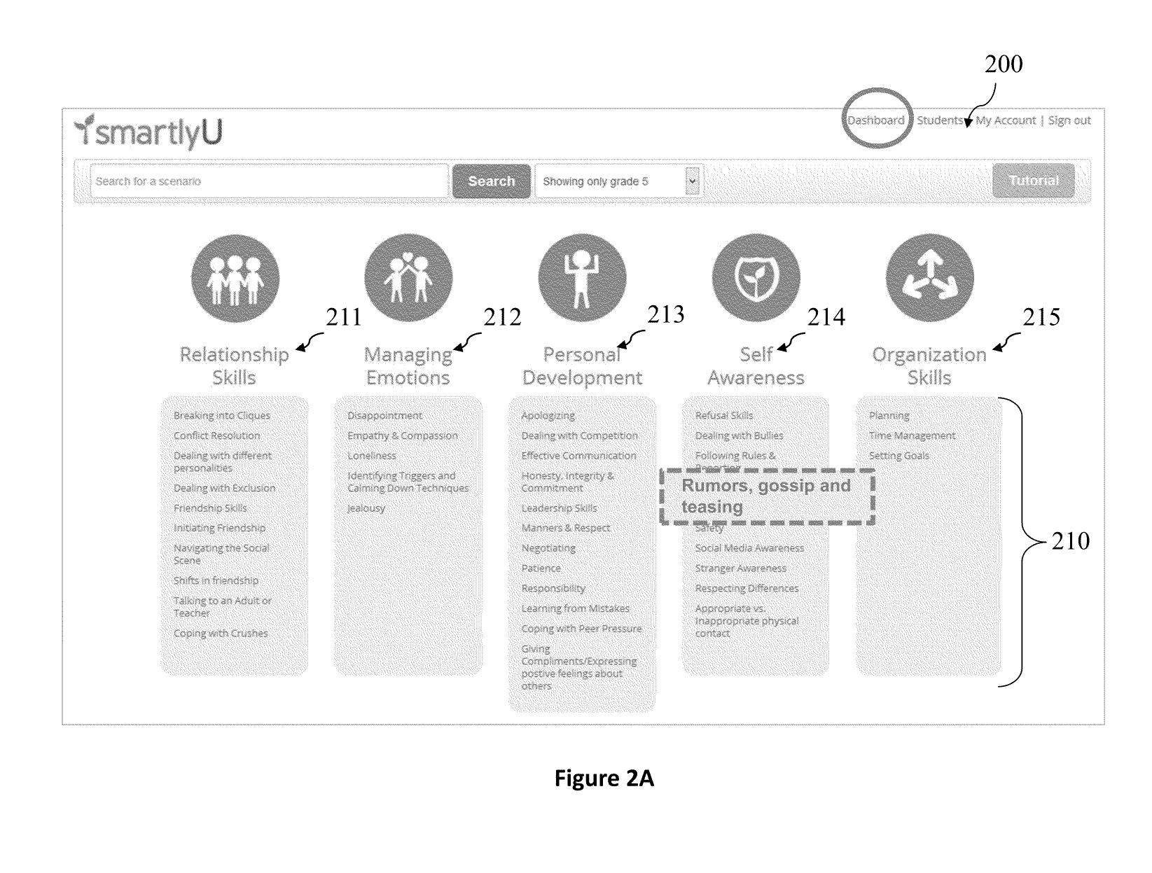

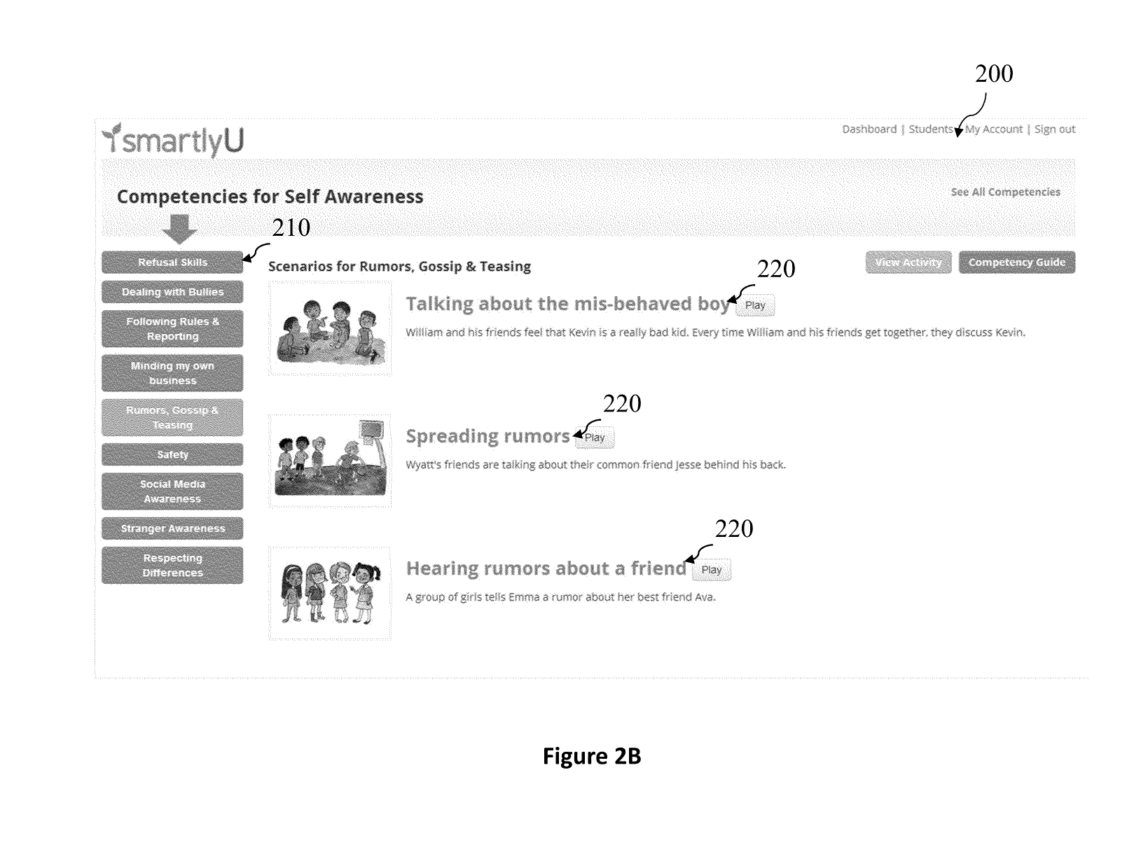

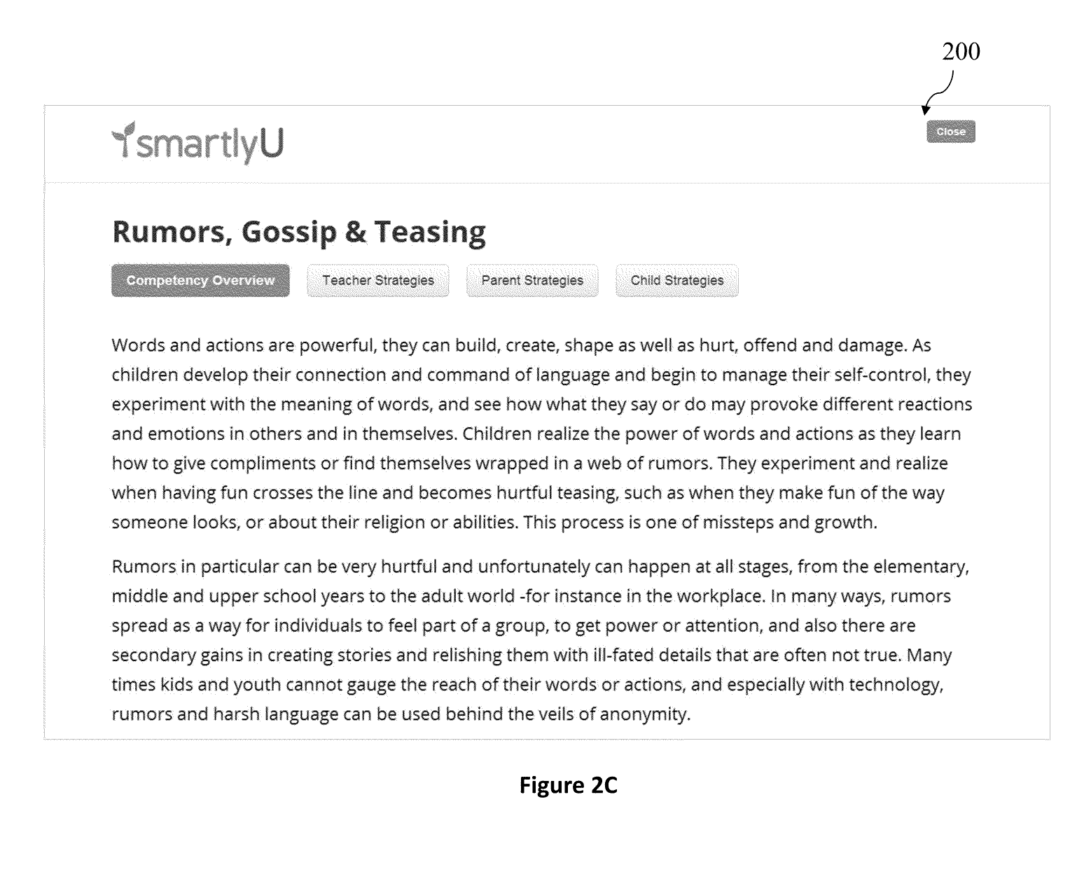

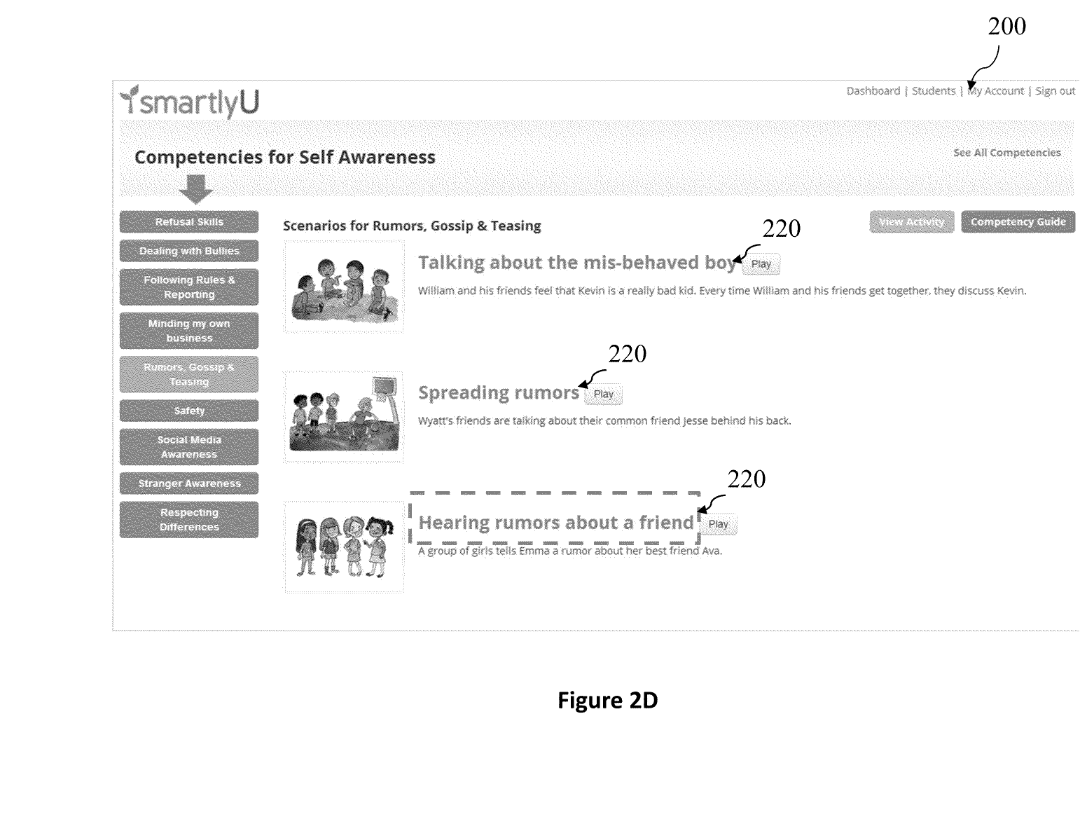

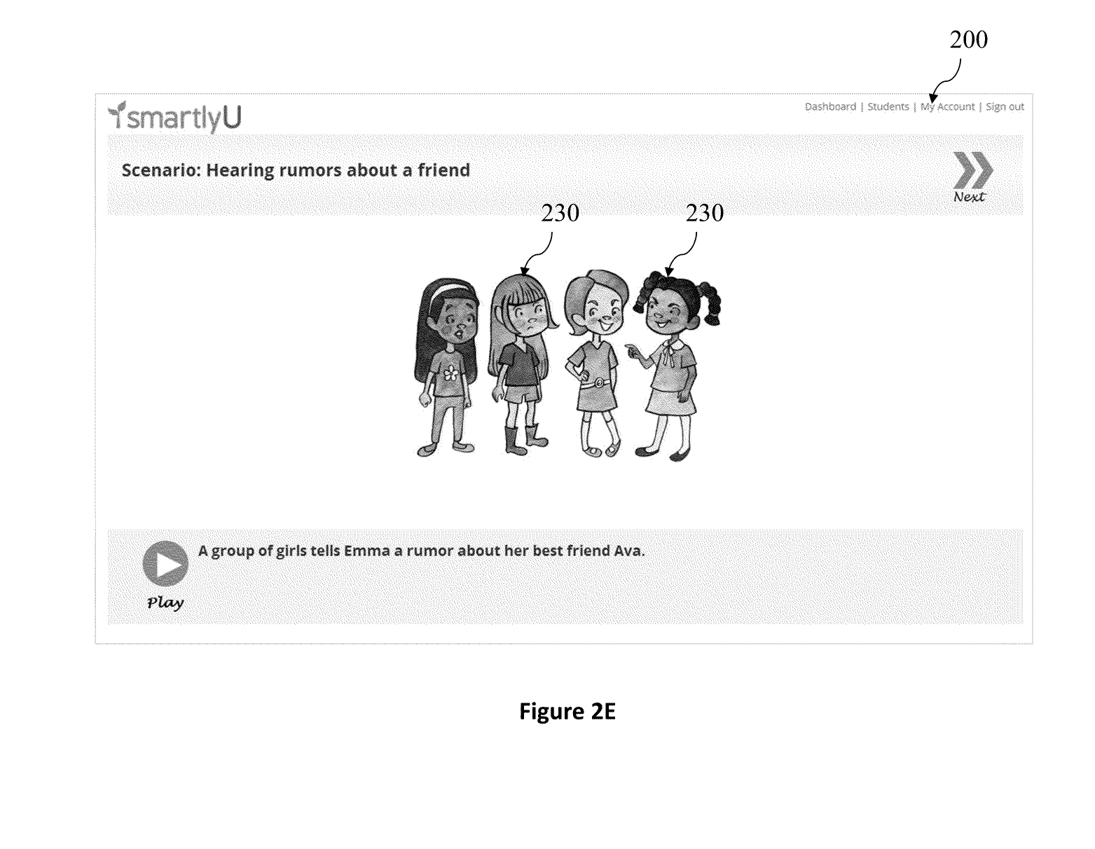

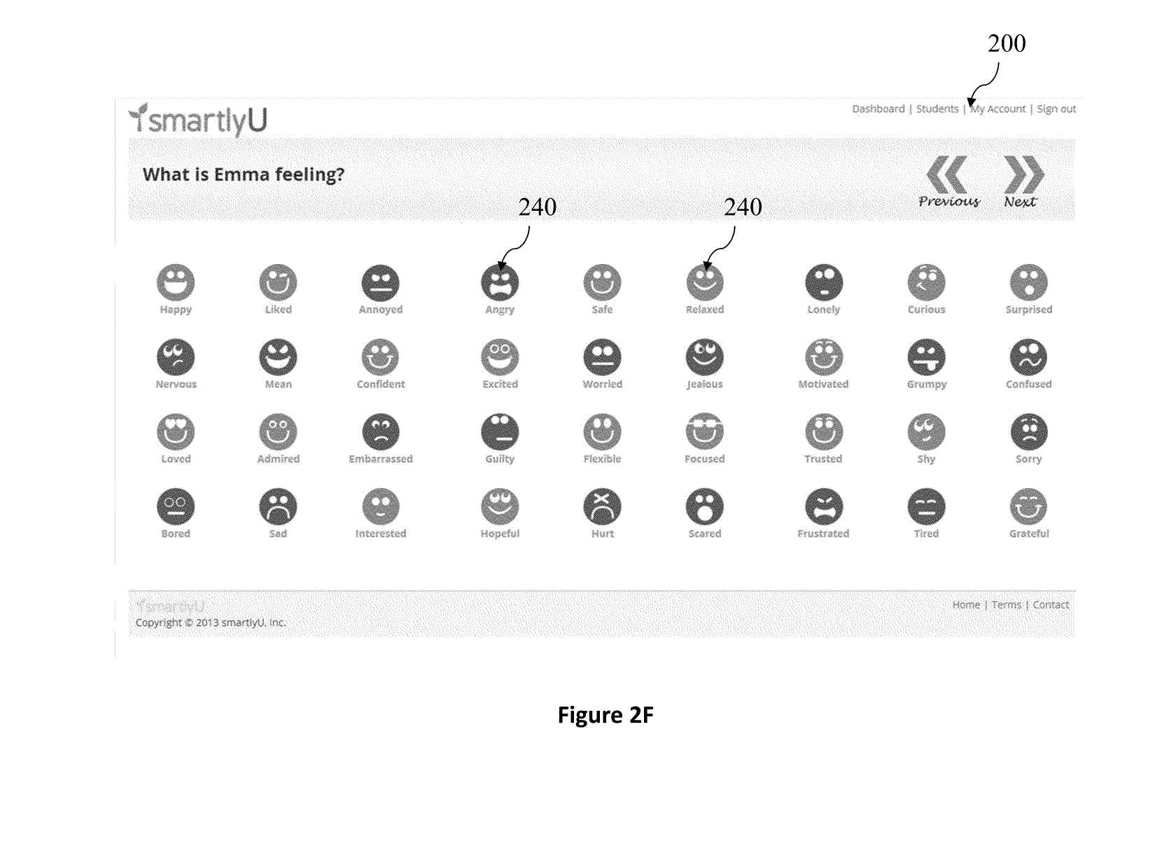

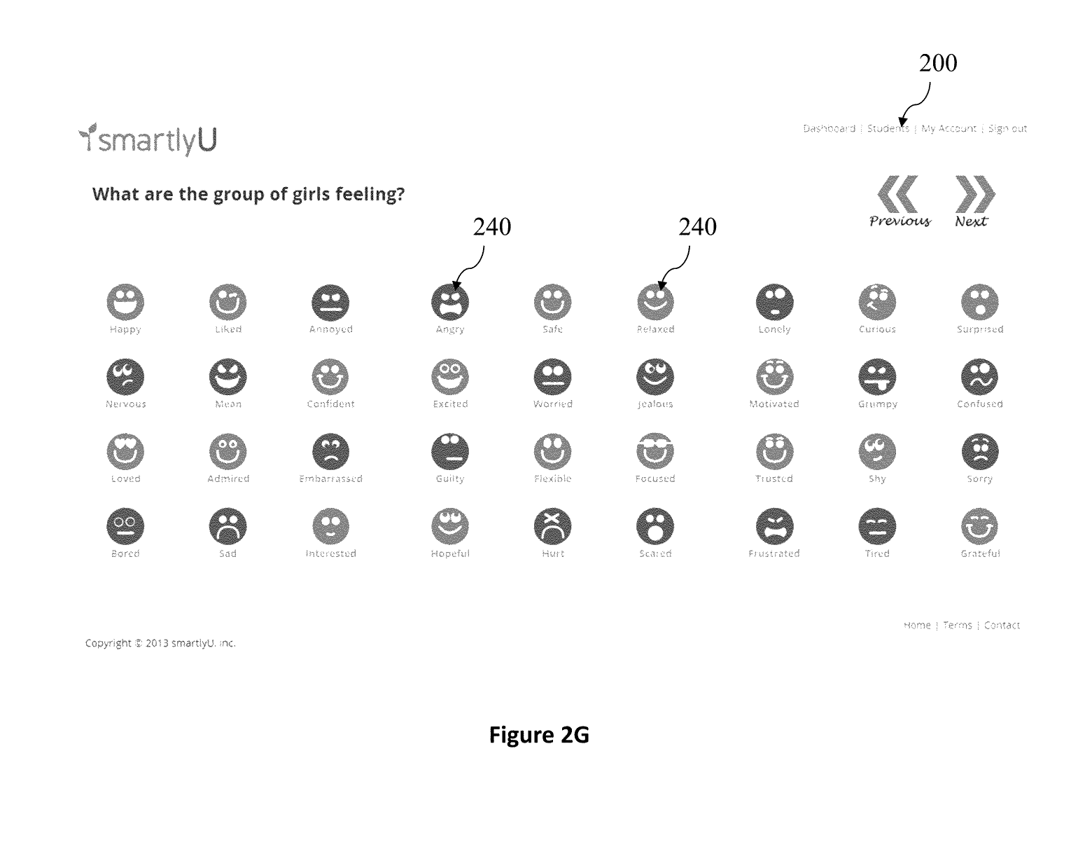

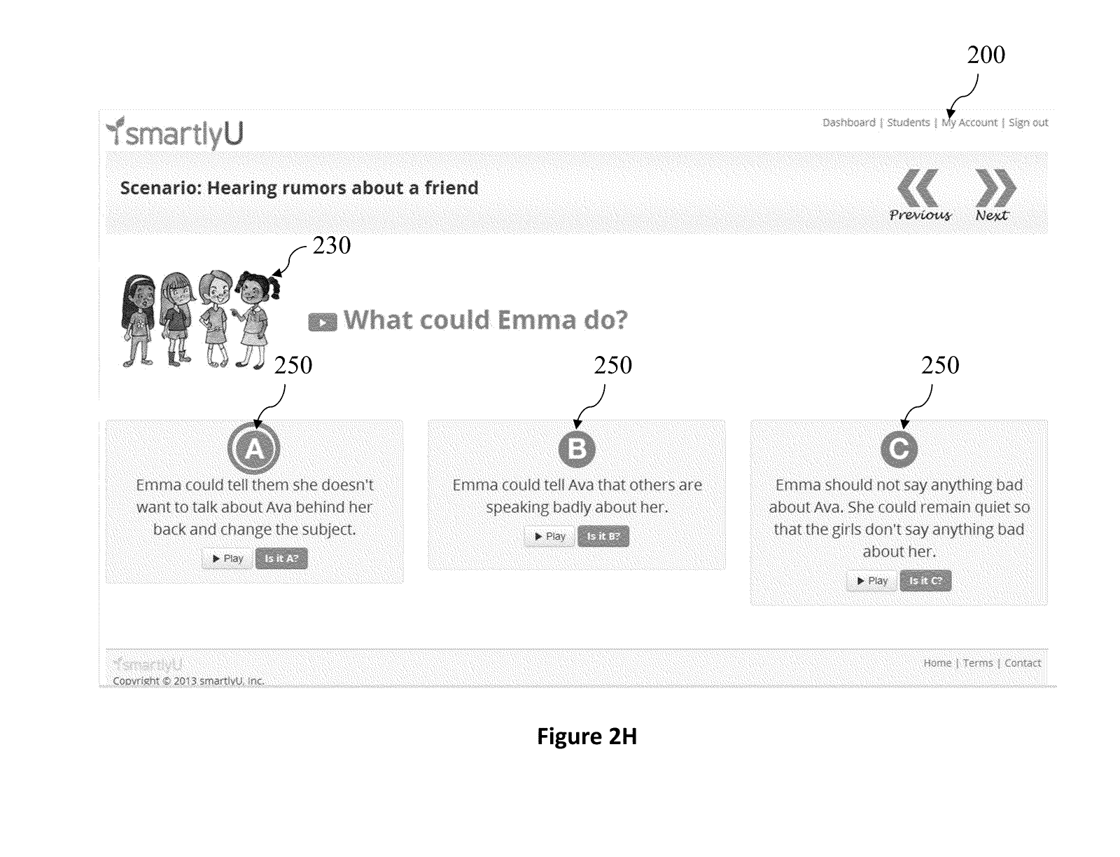

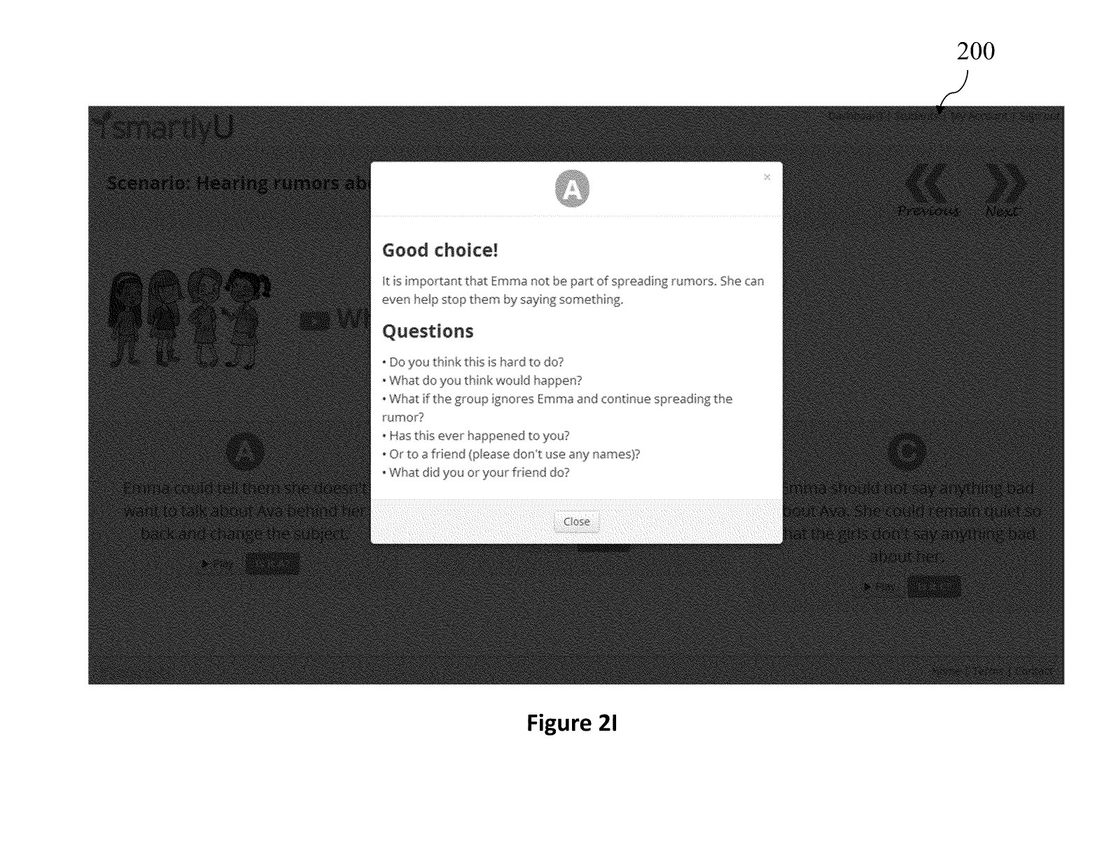

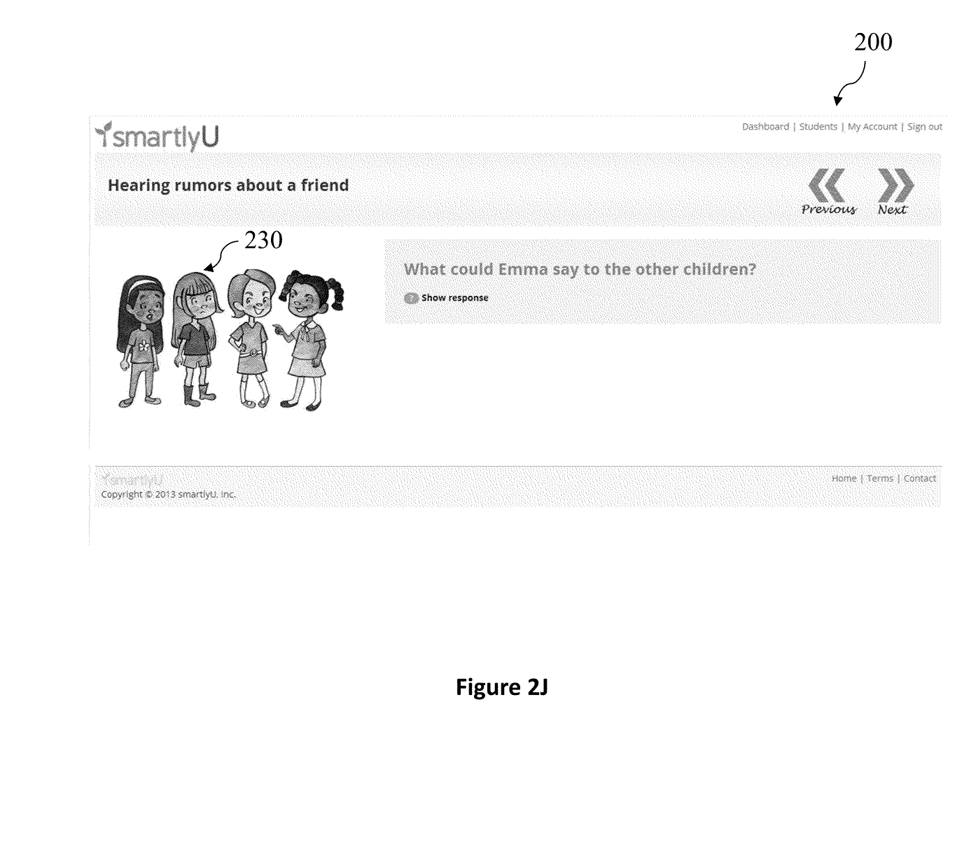

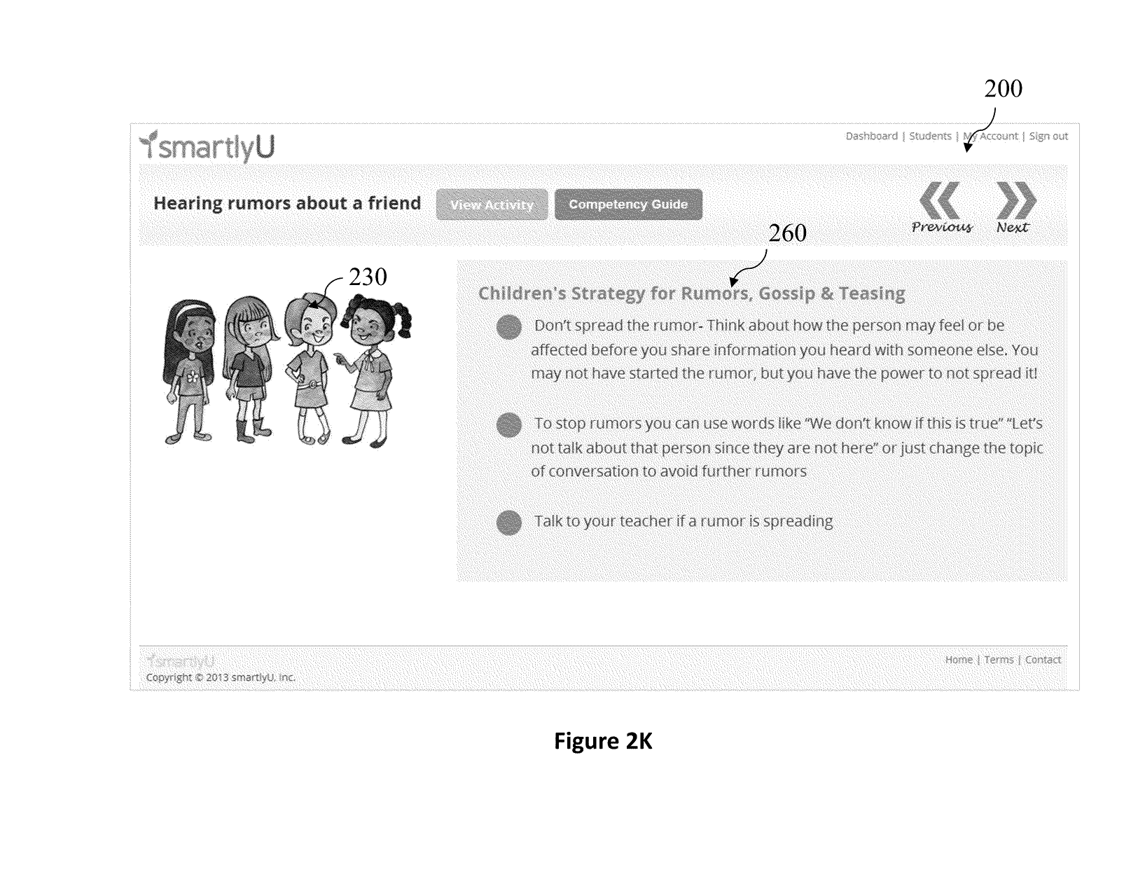

The disclosed system and its associated application provide SEL tools via competencies and education scenarios that are developmentally appropriate for each age range. An education scenario can include an interactive multi-media simulation of a real life situation that involves at least one child character. For example, FIG. 2E shows an education scenario that plays a simulation of a real life situation in which a group of girls tells Emma a rumor about her best friend Ava. These education scenarios cover a broad range of social emotional competencies such as Friendship, Conflict, and Negotiation etc. The education scenarios are what children encounter in their daily life at school, home and community. The student interacts with the education scenario by evaluating their feelings, choosing appropriate responses and builds reasoning to support their response. The student can also discuss consequences of an action to get a deep understanding of the competency. Students most importantly learn the language to enable appropriate communication for each education scenario. Through this interactive process student internalize SEL concepts and build a framework to respond to social emotional situations. Each education scenario can be depicted by graphics and voice over that showcase the emotions and setting related to the education scenario.

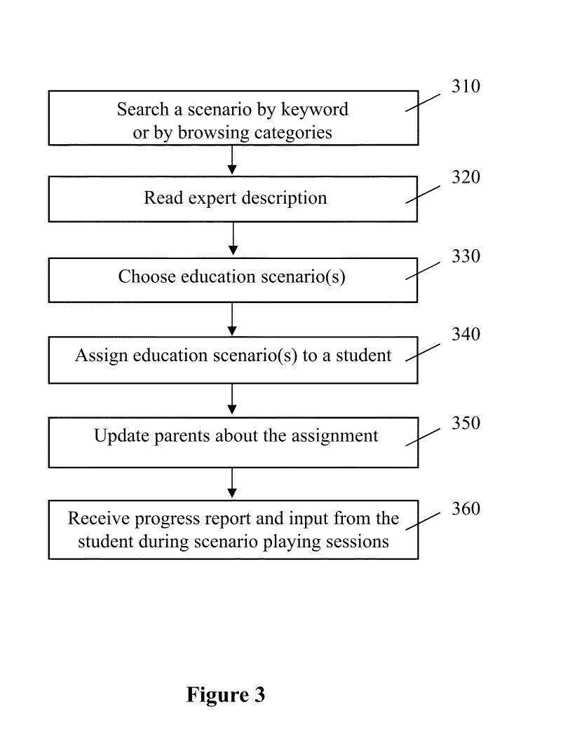

When a disclosed system is installed at a school, a teacher is provided with a username and password. A teacher can conveniently access the network-based system 100 to work with parents, counselor, and child psychologists to help students in social emotional learning. A teacher can search for education scenarios based in the situations that the children the class are facing and either have the children work through these education scenarios in the class as a whole or in small groups or one-on-one with the teacher. For example, a teacher can create a developmental plan for a class' social emotional learning, and set aside a time period that is dedicated to use the disclosed SEL application. In another example, a child may have displayed specific social emotional behaviors that require specific education. Referring to FIGS. 2A-3, a teacher can search, over the user interface 200, for and use suitable education scenarios for social emotional learning using one or more of the following steps: a teacher logs into an application supported by the network-based system. Depending on the situation and needs at hand, the teacher can search for a suitable education scenario by keywords for a student (FIG. 2A). The teacher can also search scenarios by browsing categories and subcategories of competencies in a dashboard (FIGS. 2A-2B) (step 310).

The content database 61 stores situations which are organized in buckets, searchable by tags and keywords. The user databases 62 store children's EQ learning history, teacher and parent feedback, and developmental growth path forward. The intelligent module 63 can analyze the choices selected by children as input to recommend next situation study, communication for parents or teachers.

Referring to FIG. 2A, the disclosed system broadly defines social emotional learning in several core competencies 210: relationship skills 211, managing emotions 212, personal development 213, self-awareness 214, and organization skills 215, which can be shown in a user interface 200. Each of the categories can include multiple competencies. For example, the category of relationship skills 211 can include competencies such as break into cliques, conflict resolution, dealing with different personalities, dealing with exclusion, friendship skills, initiating friendship, navigating the social scene, shifts in friendship, talking to an adult or teacher, coping with crushes, dealing with perfectionism, dealing with family transitions. The category of managing emotions 212 can include disappointment, empathy and compassion, loneliness, identifying triggers and calming down techniques, jealousy, and grief and loss. The category of personal development 213 can include apologizing, dealing with competition, effective communication, honesty, integrity and commitment, manners and respect, negotiating, patience, responsibility, learning from mistakes, coping with peer pressure, giving compliments/expressing positive feelings about others. The category of self awareness 214 can include leadership skills, refusal skills, dealing with bullies, following rules and reporting, minding my own business, rumors, gossip and teasing, safety, social media awareness, stranger awareness, respecting differences, appropriate vs. Inappropriate physical contact. The category of organization skills 215 can include planning, time management, and setting goals.

In response to keywords or browsing such as “Rumors, gossip and teasing” in FIG. 2A, a ranked list of appropriate education scenarios 220 that correspond with the keywords entered by the teacher, as shown in FIG. 2B. The education scenarios are built to be developmentally appropriate, i.e. a child that is in the 1st grade may not understand all the SEL issues that a 3rd grader would have to contend with. Each education scenario 220 comes with an expert explanation in the form of a “competency guide” (or “expert card”) that provides the teacher or parent guidance on the competency. Education scenarios 220 cover a breadth of topics within a category such as: personality types e.g. an introverted child, extroverted child, bossy child, meek child, etc., diverse culture e.g. accents, ethnicity, etc., and physical and mental handicaps, e.g. learning disabilities. A teacher can read competency description (FIG. 2C) of the categories and competencies (step 320) to find the most relevant education scenario for the situation at hand (i.e. the specific needs of a child). The teacher can browse the categories and competencies in the categories, and to choose appropriate the education scenarios 220 (FIG. 2D) (step 330) such as “hearing rumors about a friend”.

The teacher can assign the education scenarios 220 to one or more students for them to play (step 340) on devices available to the students in school or at home. The teacher can also update parents about the assignment in electronic messages, and request their participations to help the children to complete their training activities (step 350). After the student has worked on the education scenarios (details described below), the teacher can receive a report from the disclosed system (step 360). The report can include the input by the student during the playing session, the number of times that a student has played an education scenario, and other statistics. The teacher can get input, review the completed scenario, delete assigned scenarios, and assign new education scenarios 220 to the students.

Referring to FIG. 2E, an education scenario is launched to simulate a real life situation in which a group of girls (i.e. child characters 230) tells Emma a rumor about her best friend Ava. After the education scenario is played, a user such as a child user is shown a multi-choice list of feelings 240 that one or more characters in the scenario may feel. For example, as shown in FIGS. 2F and 2G, the user can be asked what Emma or the group of girls is respectively feeling. The user is asked to select one or more feelings 240 from the list of feelings 240 that the user thinks the characters in the education scenario 220 may possess in response to the situation played.

The disclosed application can provide feedback to the user about the user's selection of feeling, and suggest other feelings that the characters may have in the situation. The purpose of this step is to help the user to think from other people's points of views, and also broaden the user's scope to take into account the different feeling that could occur due to the different backgrounds of the characters in the situation.

Next, referring to FIG. 2H, the child user is then presented a list of choices about the actions 250 that the child character(s) should take in the real life situation simulated. One or more of these choices can be considered to be the “good choice”. Students make their selection and the teacher or parent is provided with an expert guidance for each selection. The student may pick choice A, as indicated by the circle around A in FIG. 2H. In some embodiments, the child user is asked directly about what she or he would do in such a situation, which may enable the child user to brainstorm action and develop “empathy” by putting himself or herself into the “shoes” of the characters in the education scenario 220.

The disclosed system and application can provide feedback or “Expert Guidance” to the user's choice on actions 250, as shown in FIG. 2I. The “Expert Guidance” can be developed by child psychologists to provide guidance to the overall broad education scenario, to the specific education scenario, to the feelings 240 or the actions 250 selected by the user. Alternatively, a teacher or a parent can receive a child user's input on the feelings 240 or the actions 250, and prompt further questions to a student to probe the child on a “good choice” answer.

In some embodiments, the child user may be presented with a list of choices or options having a corresponding suggested “consequence”. The child user can investigate each choice and explore consequences beyond the suggested consequence. The disclosed system and application can also provide the opportunity for the child user to deeply understand a competency. For example, the competency “Rumors, Gossip and Teasing” can be explored by the child user in detailed guided discussions framework presented by the system to deepen the child user's understanding on the competency being discussed.

In some embodiments, parents and adults can also educate themselves with the details required to answer questions the child might bring up. Additionally the Competency Guides provide developmental milestone material and accompanying strategies related to the education scenario. Example scenario: My school has many cliques and it is very hard to break into them. The Competency Guide might suggest that this scenario and the related behavior are not uncommon for this age group and strategies are recommended. The strategies recommended relate to strategies that the parent can use, strategies that a teacher can employ in the classroom, and strategies that a child can use. Teachers can find resources such as books or external websites for more details on the topic. Parents who might have otherwise responded emotionally to a situation can now make better choices. In the situation, a suggested strategy might be—parents might need to arrange play dates with one child in the clique to help foster one-on-one interaction. The teacher strategy on the other hand can suggest putting processes in place to address the scenario, e.g. empower the cliques by suggesting that leadership qualities can be built by inclusion or the teacher can make an introduction to a child that is trying to break in. Strategies for the child for this scenario might include role play of how to introduce oneself to one person in the clique and circle back with an adult on how that strategy worked, etc.

Moreover, referring to FIG. 2J, specific question can be asked regarding the action to guide the user articulate the verbal messages or think about non-verbal actions. At the end of the scenario playing, referring to FIG. 2K, the disclosed system and application can provide a summary of general strategies 260 for children to address a situation such as rumors, gossips and teasing.

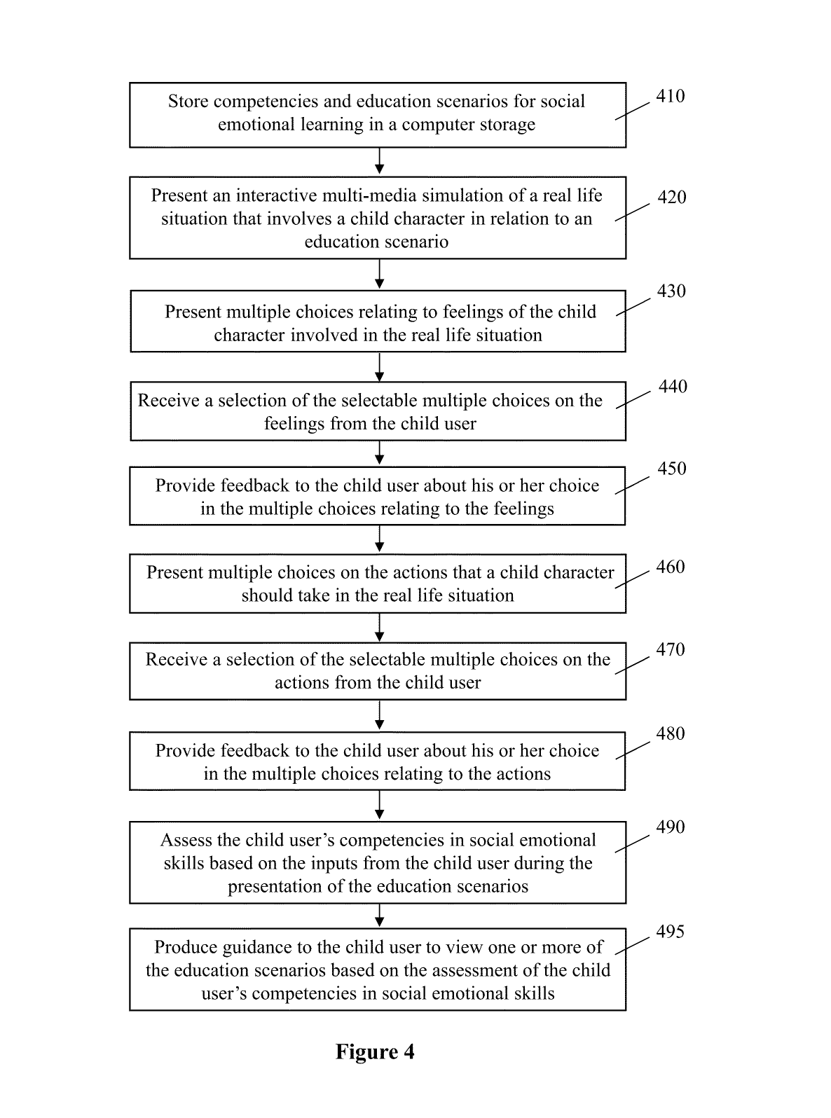

Referring to FIG. 4, a process for social emotional learning can include one or more of the following steps: as disclosed above competencies and education scenarios for social emotional learning in computer storage (step 410) such as the content database 61 (FIG. 1). An education scenario can be started by a student, a teacher, a parent, a counselor, et al. An interactive multi-media simulation of a real life situation is presented to a child user or other users. The real life situation involves a child character in relation to the education scenario (step 420). The presentation can include playing audio clips that can include dialogue between the characters in the education scenario or narratives explaining the background, the sequence of events, and an outcome of the scenario. Teacher and parents may not be familiar with the language a child uses in a scenario. The disclosed education scenarios use the appropriate language that children use to communicate their feelings. The multi-media presentation can exist in many different forms such as a sequence of interactive interlinked HTML pages, a slide show, images, video, motion pictures, and games. The interactivity, the use of children language, and the playful features make it fun for children to social emotional skills.

Multiple choices relating to feelings of the character involved in the real life situation are presented in the multi-media simulation (step 430). The child user is asked to make a selection of one of the feelings in the multiple choices. A selection of the multiple choices on the feelings is received from the child user (step 440). A feedback is provided in the interactive multi-media simulation by the disclosed system (the intelligent module 63 in FIG. 1), to the child user about his or her choice in the multiple choices relating to the feelings (step 450). In one aspect, the feedback can include more “correct” answers to the feelings of the characters in the real life situation. In another aspect, the feedback can provide other perspectives to child user's choices, which may accurately represent his or her understanding of the situation but can be broadened to include other possibilities.

A purpose of the feature relating to feeling selection is to test and understand the level of understanding a social emotional situation, which is the first essential part of SEL. Another purpose of this feature is to train the child user with a variety of social emotional descriptive terms, which is very beneficial in helping the child user to articulate his or her emotions in their real lives. A goal and a benefit of the disclosed system and methods are to help children to express their feelings. Another purpose of the disclosed system and methods is to allow parents, teacher, and facilitator to drill further on why a child picks a certain feeling that may not immediately relevant to the education scenario.

The multi-media simulation presents multiple choices on the actions that a child character should take in the real life situation (step 460). A selection of the selectable multiple choices on the actions is received from the child user (step 470). The disclosed system (the intelligent module 63 in FIG. 1) provides a feedback to the child user about his or her choice in the multiple choices relating to the actions (step 480). The actions can include verbal or non-verbal communications that the characters in the education scenario can take to handle the situation. The action may also include consequences that may result from the particular action. The actions can also take tasks that the characters in the education scenario should do (e.g. discussing with teacher, parent, or counselor about the situation, or writing an “apology” or “thank you” note or card for another character in the education scenario.

The disclosed system (the intelligent module 63 in FIG. 1) assesses the child user's competencies in social emotional skills based on the inputs from the child user during the presentation of the education scenarios (step 490). The inputs include the selections by the child user on the feelings and actions, including the sequence of the selections. Importantly, the input from the child also includes results of the child user's practices of the learning from the education scenarios. The degree of success of practicing the learning is quantitatively captured by the intelligent module 63 (FIG. 1).

The intelligent module 63 (FIG. 1) in the disclosed system can produce guidance to the child user to view one or more of the education scenarios based on the assessment of the child user's competencies in social emotional skills (step 495). In some embodiments, the guidance is also in part based on a goal for the child user to achieve a level of social emotional skills. The goal is age dependent. For example, a third grader is expected to achieve certain level of social emotional proficiencies at the end of the school year. If a child is falling behind in certain social emotional competencies or an entire category of competencies, the disclosed system (i.e. the intelligence module) can produce guidance to the child user to specifically view one or more education scenarios in the categories in which the child is deficient. The new assignments can thus depend on the gap between the current level of social emotional skills and the goal for a child user.

A history of a child user's viewing and input of education scenarios, the social emotional goals for child user, assessment of the child user's social emotional proficiencies can be stored in computer storage (e.g. user database 62 in FIG. 1).

### Physical Activity to Practice Education Scenarios

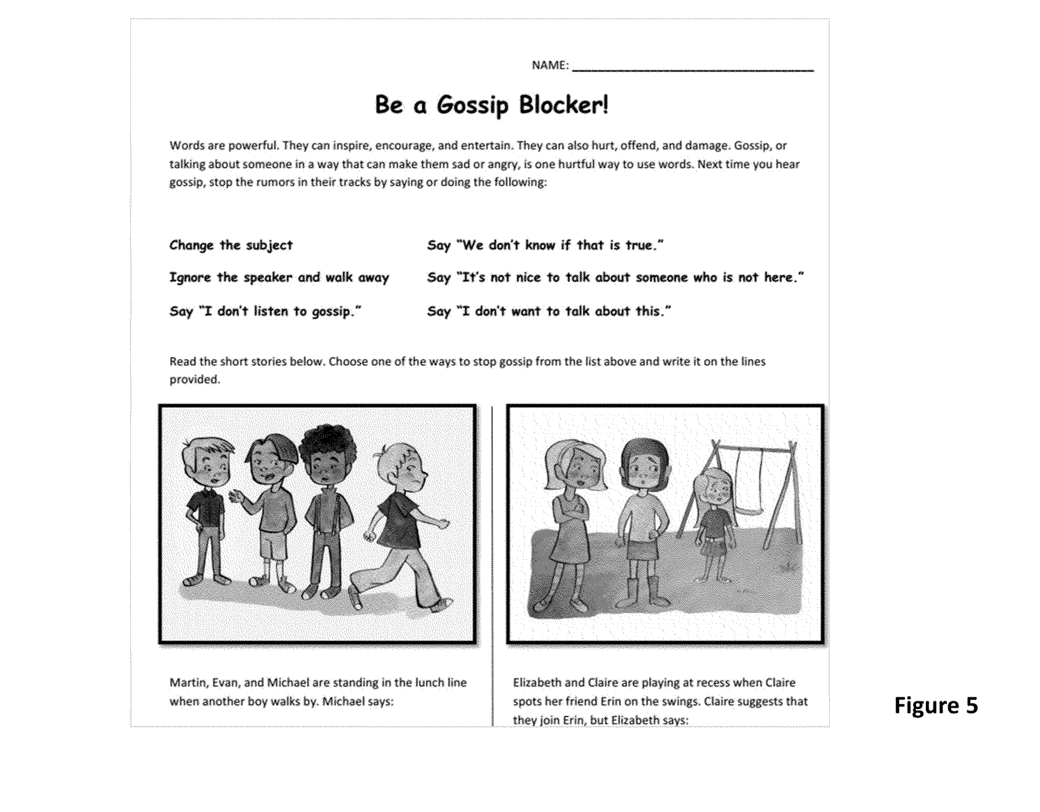

In some embodiments, referring to FIG. 5, the disclosed education scenarios can be provided with worksheets for physical training exercises associated respective multi-media education scenarios. A teacher can print out a worksheet and guide students to play roles in classrooms to further enforce the learning after the sessions of playing multi-media education scenarios. The worksheet can include the general strategies on how to properly handle a social emotional situation, as shown in FIG. 2M.

### Developmental Growth Path

The disclosed system and methods can enable parents and teachers to develop a customized development plan based on a specific child's social emotional competencies. The parents and teachers can choose specific categories that they feel the child needs further development in. For example: Within the category of Friendship, they might select “Feeling Lonely” or “Breaking into Groups” etc. After they make the selections a series of “programs” or “plans” are built consisting of a combination of scenarios. These scenarios are selected based in the weighting assigned in the systems. As a child completes a “program”, new programs can be created either with the same categories or choosing issues in a new set of categories.

Parents and teachers can communicate with each other on the progress and questions that come up. They may then choose to put together a specific plan to address the issues that might need further intervention. For example, if a child has viewed scenarios suggests strategies to break into a group but the child practiced the suggested actions with no progress; the parent can involve the teacher to guide them in facilitating small group activities etc. The teacher may require other involved students to review scenarios to be more open and perceptible to new friends. Parents and teachers can refer to the Competency Guides for ideas and suggestions for strategies and general education on the scenarios themselves. For example, a suggestion in the Competency Guide might ask the child to take a specific action and report back to the adult. Example Scenario: My friends play chase tag at every recess and I don't like it, I have to sit out and wait till they get done. The Competency Guide suggests that the child use assertive language and negotiate that the group play Chase Tag for 10 minutes and basketball for 10 minutes. The child tries this out and reports back to the parent or teacher. The child may say that the Negotiation did not work. A parent or teacher can model it to the child and ask how the child asked their friends. At this point the Competency Guide will suggest alternative strategies such as guiding the child to broaden their friendships by making new friends where they share common interests.

Buckets of situations can be quantized in a multi-dimensional space. Each child can have a developmental plan (e.g. at the beginning of each academic year). For example, each of the main categories (shown in FIG. 2A) can be a quantifiable variable Yₙ, wherein n is an integer (e.g. n=1, 2, 3, 4, or 5), which is defined by a dimension in the social emotional proficiency space. The plan traces a plurality of situational topics in a development growth path specific to that child in the multidimensional space. Situation topics can be gradually changed from one to the next by different weights in the tags. The plan is stored in the user database 62 (FIG. 1). The intelligence module 63 (FIG. 1) regularly evaluates the progress that the child made.

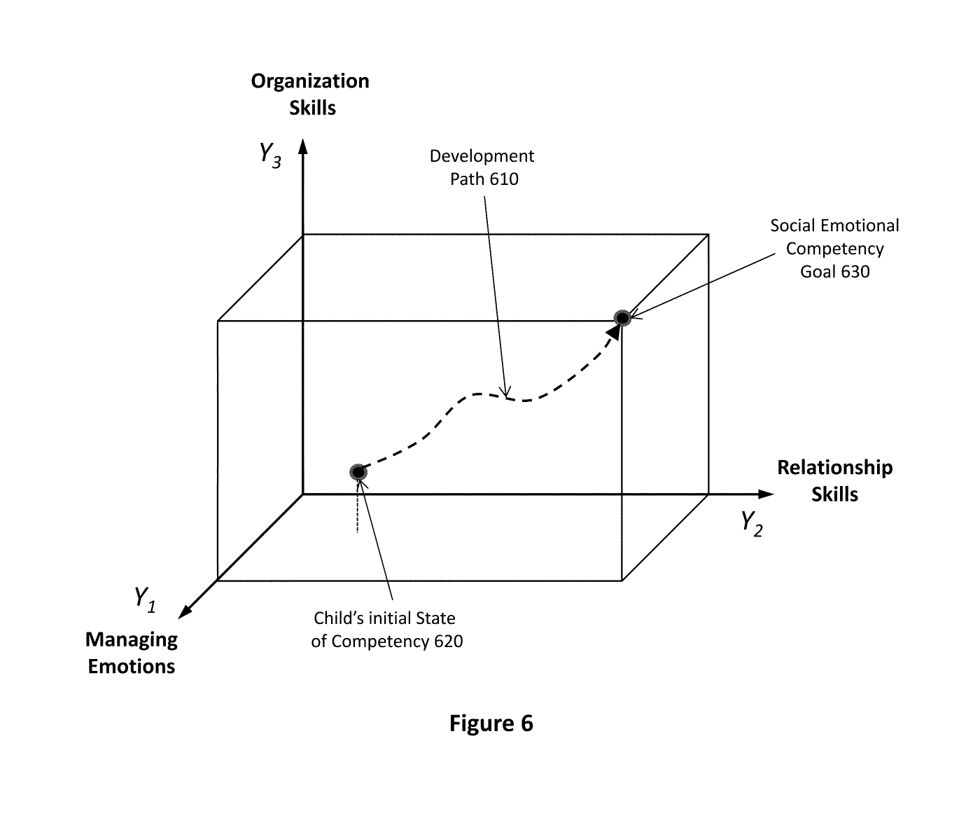

Because the disclosed system can quantitatively tracks the history of a child's social emotional learning, the social emotional development path can be quantified and visualized in virtual space. For example, FIG. 6 shows a quantitative development path 610 for developing a child's social emotional proficiencies in a social emotional space. The example shows three dimensions: managing emotions, relationship skills, and organization skills, respectively along axis Y₁, Y₂, Y₃. The intelligence module 63 (FIG. 1) quantitatively measures the child's initial sate of competency 620 as an initial location in the social emotional space. The development plan quantitatively sets a social emotional competency goal 630 for the child to achieve as a destination location in the social emotional space. The goal can be set by teachers, and/or parents, and/or counselors, and/or students in conjunction with the assistance of the intelligence module 63 (FIG. 1). A development path 610 is created at least in part with the assistance of the intelligence module 63 (FIG. 1) in the social emotional space. The intelligence module 63 (FIG. 1) monitors the progress the child user makes along the development path 610 until his or her goal is achieved. A teacher or a counselor can share the development plan for a child with the parent. The teacher, the parent, and the counselor can easily visualize the progress the child has made and the gap remaining using the application supported by the disclosed network-based system 100.

In tracking a child's social emotional learning, each education scenario can be tagged by key words (including words in the title and the content of the scenario), and keywords that do not appear in the scenario. For example: Scenario titled: “Feel lonely at School” might also be tagged with the keyword “excluded”. The disclosed network-based system assigns weights to tags based on its relevance to the competency that the specific scenario is discussing and its connection to the other competencies in the systems. Each tag can be weighted by a numerical number such as 1-10. For example: If the scenario category is “Negotiating” and it refers to negotiating with friends in the playground around choosing a specific game or activity—the tags might include: Tag: Friendship|Weight: 7, Tag: Conflict|Weight: 10, Tag: School Issues|Weight: 2 etc. Keyword search is based on tags and weights of the tags. The completion of certain education scenario will increase the child's social emotional proficiencies, that is, moving forward along the development path 610. Importantly, the disclosed method provides a verification mechanism to receive from the child about the results of his or her daily practice of the learning from the education scenarios, and his or her degrees of success, which are also quantitatively captured in the progress measurement along the development path.

### Examples of Other Use Cases

In a classroom, a teacher can proactively present education scenarios and engages the students in a guided discussion of the education scenario. The teacher uses the provided “Competency Guide” or child psychologist guidance to educate themselves on the situation and on the responses.

A teacher can also use the disclosed application in the “Search Mode” and reactively looks up an education scenario that they would like to address with the whole class or group of students. An example of such a search may result if students were excluding a child or group of children from a game or a group of children were gossiping about another child.

A teacher or principal might want to assign a certain education scenario to a parent. This education scenario might depict underlying issues that the student is facing at school. Maybe she/he is bossy, or lonely or disrespectful. The parent then in a guided discussion of education scenarios with the child at home.

A child psychologist can use the disclosed application with children that might have social issues. They will walk through the education scenarios and ask pointed questions assessing the child's feelings, response and asking “what if” questions.

A parent can use the disclosed application reactively. As situations come up parents can search for education scenarios and use the system with their child to help uncover their feelings, discuss actions they can take and teach their children strategies to address the situation.

A student can study situations provided by teachers or parents. The student can request for recommendations. The student can share situations with friends. Achievement points, gold stars can be given the student: for example, a student can achieve a high level (e.g. black belt) of social emotional learning in the disclosed system.

A parent or teacher may purchase a membership with the network-based system 100 (FIG. 1). Members can post questions in the discussion boards powered by the network-based system 100 (FIG. 1). They are provided with an anonymous username and a licensed child psychologist answers the questions. Members may also actively search the discussion boards for specific issues. Members may post to a discussion threads. Members can also follow specific threads of discussions. Members will also have access to child psychologists that they may privately consult with.

The disclosed system and methods provide the flexibility to the user based on the length of time available. For example, a teacher or parent can tailor the training as follows:
5 minutes: Scenario presentation and Actions
10 minutes: Scenario presentation, Feelings and Actions
15 minutes: Scenario presentation, Feelings, Actions, Communication, and Consequences
20 minutes: Scenario presentation, Feelings, Actions, Further Questions, Communication

Only a few examples and implementations are described. Other implementations, variations, modifications and enhancements to the described examples and implementations may be made without deviating from the spirit of the present invention. For example, the disclosed system, methods, applications, and user interfaces can be implemented using hardware or software other than the examples described above.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination.

It will thus be seen that the objects of the present invention have been fully and effectively accomplished. Its embodiments have been shown and described for the purpose of illustrating the functional and structural principles of the present invention and is subject to change without departure from such principles. Therefore, this invention includes all modifications encompassed within the spirit and scope of the following claims.

What is claimed is:

1. A network-based education system for providing social emotional education, comprising:
a computer storage configured to store a plurality of competencies for social emotional learning and education scenarios for the plurality of competencies;
one or more servers configured to enable one of the education scenarios to be presented on a user device, wherein the one or more servers are configured to receive an input from a child user in response to the presentation of the one of the education scenarios,
wherein the computer storage is configured to store a child user's history in viewing the education scenarios, input from the child user during the presentation of the education scenarios, and an assessment of the child user's competencies in social emotional skills; and
an intelligence module configured to assess the child user's competencies in social emotional skills based in part on the input from the child user during the presentation of the education scenarios.

2. The network-based education system of claim 1, wherein at least one of the education scenarios includes an interactive multi-media simulation of a real life situation that involves at least one child character.

3. The network-based education system of claim 2, wherein the interactive multi-media simulation includes selectable multiple choices relating to feelings of a child character involved in the real life situation, wherein the one or more servers are configured to receive a selection of the selectable multiple choices from the child user.

4. The network-based education system of claim 3, wherein the interactive multi-media simulation includes a feedback to the child user's choice in the multiple choices relating to the feelings.

5. The network-based education system of claim 2, wherein the interactive multi-media simulation of the real life situation includes selectable multiple choices for actions that a child character involved in the real life situation should take, wherein the one or more servers are configured to receive a selection of the selectable multiple choices from the child user.

6. The network-based education system of claim 5, wherein the interactive multi-media simulation includes a feedback to the child user's choice in the multiple choices for actions.

7. The network-based education system of claim 1, wherein the interactive multi-media simulation of the real life situation includes verbal communications involving at least one child character.

8. The network-based education system of claim 1, wherein the interactive multi-media simulation of the real life situation includes non-verbal communications involving at least one child character.

9. The network-based education system of claim 1, wherein the intelligence module is configured to produce guidance to the child user to view one or more of the education scenarios based on the assessment of the child user's competencies in social emotional skills.

10. The network-based education system of claim 1, wherein the computer storage is configured to store a goal for the child user to achieve a level of social emotional skills, wherein the intelligence module is configured to produce guidance to the child user to view one or more of the education scenarios based on the goal for the child user.

11. The network-based education system of claim 1, wherein the one or more servers are configured to enable one of the education scenarios to be presented to the child user based on an age of the child user, wherein the intelligence module is configured to assess the child user's competencies in social emotional skills based in part on the age of the child user.

12. The network-based education system of claim 1, wherein the one or more servers are configured to receive an assignment from a teacher, a parent, or a counselor to require the child user to view one or more of the education scenarios based on the assessment of the child user's competencies in social emotional skills.

13. The network-based education system of claim 1, wherein the one or more servers are configured to send an electronic notification to a teacher, a parent, or a counselor after the child user has reviewed one or more of the education scenarios.

14. The network-based education system of claim 1, wherein the plurality of competencies are stored in a category selected from the group consisting of relationship skills, managing emotions, personal development, self-awareness, and organization skills.

15. The network-based education system of claim 1, wherein the one or more servers are configured to enable presentation of the one or more education scenarios in a web browser run on the user device, or in a mobile user interface.

16. A computer-implemented method for providing social emotional education, comprising:
storing, in a computer storage, a plurality of competencies for social emotional learning and education scenarios for the plurality of competencies, wherein at least one of the education scenarios includes an interactive multi-media simulation of a real life situation that involves at least one child character;
enabling one of the education scenarios to be presented on a user device;
receiving an input from a child user in response to the presentation of the one of the education scenarios;
storing, in the computer storage, a child user's history in viewing the education scenarios, input from the child user during the presentation of the education scenarios, and an assessment of the child user's competencies in social emotional skills; and
assessing, by an intelligence module, the child user's competencies in social emotional skills based on the input from the child user during the presentation of the education scenarios.

17. The computer-implemented method of claim 16, further comprising:
presenting, in the multi-media simulation, selectable multiple choices relating to feelings of the child or the children involved in the real life situation;
receiving a selection of the selectable multiple choices from the child user; and
providing a feedback to the child user about his or her choice in the multiple choices relating to the feelings.

18. The computer-implemented method of claim 16, further comprising:
presenting, in the multi-media simulation, selectable multiple choices for actions that a child character should take in the real life situation;
receiving a selection of the selectable multiple choices from the child user; and
providing a feedback to the child user about his or her choice in the multiple choices relating to the actions.

19. The computer-implemented method of claim 16, wherein the input from the child includes results of the child user's practices of learning from the education scenarios.

21. The computer-implemented method of claim 16, further comprising:
producing guidance, by the intelligence module, to the child user to view one or more of the education scenarios based on the assessment of the child user's competencies in social emotional skills.

22. The computer-implemented method of claim 16, further comprising:
storing a goal for the child user to achieve a level of social emotional skills in the computer storage; and
producing guidance by the intelligence module to the child user to view one or more of the education scenarios based on the goal for the child user.

23. The computer-implemented method of claim 16, further comprising:
enabling one of the education scenarios to be presented to the child user based on an age of the child user; and
assessing, by the intelligence module, the child user's competencies in social emotional skills based in part on the age of the child user.

24. The computer-implemented method of claim 16, further comprising:
receiving an assignment by the one or more servers from a teacher, a parent, or a counselor to require the child user to view one or more of the education scenarios based on the assessment of the child user's competencies in social emotional skills.

25. The computer-implemented method of claim 16, wherein the interactive multi-media simulation of the real life situation includes verbal communications involving at least one child character.

26. The computer-implemented method of claim 1, wherein the plurality of competencies are stored in a category selected from the group consisting of relationship skills, managing emotions, personal development, self-awareness, and organization skills.

27. A computer-implemented method for providing social emotional education, comprising:
quantitatively defining a plurality of competencies for social emotional learning in a social emotional space that include three or more dimensions;
determining a child user's initial state of competency as an initial location in the social emotional space by an intelligence module in a network-based system;
setting a goal for social emotional competence for the child user as a destination location in the social emotional space;
creating a development path in the social emotional space at least in part with the assistance of the intelligence module;
providing education scenarios for the plurality of competencies for the child user to practice, wherein at least one of the education scenarios includes an interactive multi-media simulation of a real life situation that involves at least one child character; and
monitoring the child user's progress along the development path by the intelligence module.

28. The computer-implemented method of claim 27, further comprising:
enabling one of the education scenarios to be presented on a user device;
receiving an input from a child user in response to the presentation of the one of the education scenarios;
storing, in the computer storage, a child user's history in viewing the education scenarios, input from the child user during the presentation of the education scenarios, and an assessment of the child user's competencies in social emotional skills; and
assessing the child user's competencies in social emotional skills based on the input from the child user.

29. The computer-implemented method of claim 27, further comprising:
sharing the development path or the child user's progress along the development path to a parent of the child user.
